(19) United States
(12) Patent Application Publication
(10) Pub. No.: US 2023/0155448 A1
(43) Pub. Date: May 18, 2023

(54) INVERTER DEVICE, MOTOR, AND MOTOR UNIT

(71) Applicant: NIDEC CORPORATION, Kyoto (JP)

(72) Inventors: Daisuke OGASAWARA, Kyoto (JP); Jun MURAKAMI, Kyoto (JP); Kazuyuki YAMAMOTO, Kyoto (JP); Mizuki NIHIRA, Kyoto (JP); Keigo NAKAMURA, Kyoto (JP)

(21) Appl. No.: 17/798,081

(22) PCT Filed: Sep. 14, 2020
(86) PCT No.: PCT/JP2020/034639

§ 371 Date: Aug. 8, 2022

(30) Foreign Application Priority Data
Feb. 14, 2020 (JP) 2020-023048

(51) Int. Cl. H02K 5/24; H02K 7/116; H02K 11/33; B60L 53/20; B60K 1/00

(52) U.S. Cl. CPC H02K 5/24; H02K 7/116; H02K 11/33; B60L 53/20; B60K 1/00

(57) ABSTRACT

An inverter device capable of suppressing generation of vibration and a puddle in a top wall of an inverter case is provided. The inverter device includes an inverter and the inverter case that accommodates the inverter inside the inverter case. The inverter case has a top wall covering the inverter from above. The top wall has a first inclined surface descending from a top part on the upper surface of the top wall toward a first end part of the top wall, and a plurality of first rod-shaped ribs extending from the top part toward the first end part. The first rod-shaped rib has a site in which a protrusion height from the inclined surface increases toward the first end part.

### CROSS-REFERENCE TO RELATED APPLICATIONS

This is the U.S. national stage of application No. PCT/JP2020/034639, filed on Sep. 14, 2020, and priority under 35 U.S.C. § 119 (a) and 35 U.S.C. § 365(b) is claimed from Japanese Patent Application No. 2020-023048, filed on Feb. 14, 2020.

### FIELD OF THE INVENTION

The present invention relates to an inverter device, a motor, and a motor unit.

### BACKGROUND

In an electronic control device mounted on a vehicle or the like, a configuration in which a honeycomb-shaped rib is included in a part of a case that accommodates a circuit board is known.

In a motor unit having a structure in which an inverter case accommodating an inverter is continuous to a motor housing accommodating a motor, membrane resonance of the inverter case is liable to be excited by motor vibration generated when the motor is driven. Installation of a rib is effective for suppressing membrane resonance. However, when a closed annular rib in such as a honeycomb shape is arranged on the upper surface of the inverter case, water having entered a recess surrounded by the rib is less likely to be discharged.

### SUMMARY

According to one exemplary aspect of the present invention, there is provided an inverter device including an inverter and an inverter case that accommodates the inverter inside the inverter case. The inverter case has a top wall covering the inverter from above. The top wall includes a first inclined surface descending from a top part on an upper surface of the top wall toward a first end part of the top wall, and a plurality of first rod-shaped ribs extending from the top part toward the first end part. The first rod-shaped rib has a site where a protrusion height from the inclined surface increases toward the first end part.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic configuration view of a motor unit according to an embodiment;

FIG. 2 is a perspective view of the motor unit according to the embodiment;

FIG. 3 is a schematic cross-sectional view of an inverter device according to the embodiment;

FIG. 4 is a plan view of an inverter cover according to the embodiment as viewed from above;

FIG. 5 is a plan view of the inverter cover according to the embodiment as viewed from below; and

FIG. 6 is a perspective view of the inverter cover according to the embodiment.

### DETAILED DESCRIPTION

The following description will be made with the direction of gravity being defined on the basis of positional relationships in the case where a motor unit 1 is mounted in a vehicle on a horizontal road surface. In the drawings, an XYZ coordinate system is shown appropriately as a three-dimensional orthogonal coordinate system. In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity). An X-axis direction corresponds to a front-rear direction of the vehicle in which the motor unit 1 is mounted, and is a direction orthogonal to the Z-axis direction, and a +X direction points forward of the vehicle, while a −X direction points rearward of the vehicle.

However, the +X direction and the −X direction may point rearward and forward, respectively, of the vehicle. A Y-axis direction is a direction orthogonal to both the X-axis direction and the Z-axis direction and indicates a width direction (left-right direction) of the vehicle, and a +Y direction points leftward of the vehicle, while a −Y direction points rightward of the vehicle. However, when the +X direction points rearward of the vehicle, the +Y direction may point rightward of the vehicle, and the −Y direction may point leftward of the vehicle. That is, the +Y direction simply points to one side in the left-right direction of the vehicle, and the −Y direction points to the other side in the left-right direction of the vehicle, regardless of the direction of the X-axis.

In description below, unless otherwise specified, a direction (that is, the Y-axis direction) parallel to a motor axis J2 of a motor 2 will be simply referred to by the term “axial direction”, “axial”, or “axially”, radial directions around the motor axis J2 will be simply referred to by the term “radial direction”, “radial”, or “radially”, and a circumferential direction around the motor axis J2, that is, a circumferential direction about the motor axis J2, will be simply referred to by the term “circumferential direction”, “circumferential”, or “circumferentially”. However, the term “parallel” as used above includes both “parallel” and “substantially parallel”.

The motor unit 1 of the present embodiment is mounted on a vehicle using a motor as a power source, such as a hybrid electric vehicle (HEV), a plug-in hybrid electric vehicle (PHV), or an electric vehicle (EV), and is used as the power source.

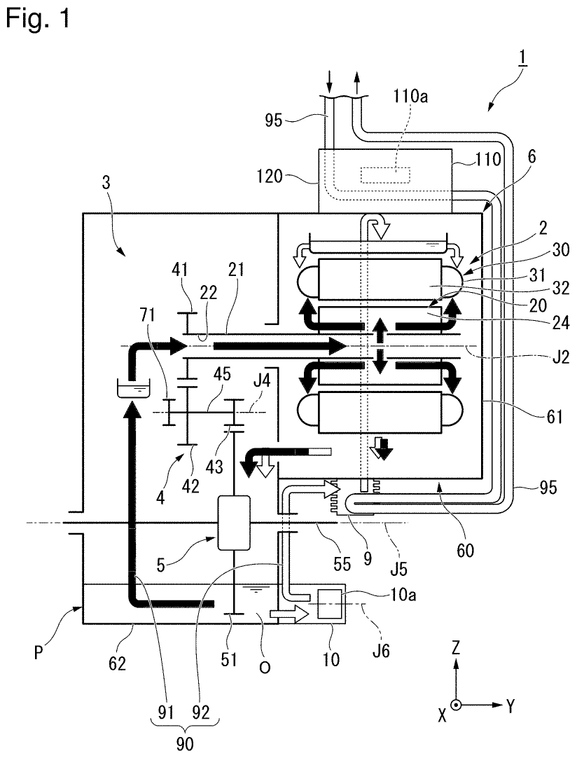

As illustrated in FIG. 1, the motor unit 1 includes the motor 2, a transmission mechanism 3, a housing 6, oil O accommodated in the housing 6, an oil cooler 9, and an inverter device 110.

The motor 2 includes a rotor 20 that rotates about the motor axis J2 extending in the horizontal direction, and a stator 30 located radially outside the rotor 20.

The housing 6 includes a motor housing 60 that accommodates the motor 2, a motor cover 61 that closes an end part on one side (−Y side) of the motor housing 60, and a gear housing 62 that is located at an end part on the other side (+Y side) of the motor housing 60 and accommodates the transmission mechanism 3.

The motor 2 is an inner rotor type motor. The rotor 20 is arranged radially inside the stator 30. The rotor 20 includes a shaft 21, a rotor core 24, and a rotor magnet (not illustrated). The motor 2 may be an outer rotor type motor.

The shaft 21 is arranged about the motor axis J2 extending in a horizontal direction and in a width direction of a vehicle. The shaft 21 is a hollow shaft having a hollow part 22 inside. The shaft 21 protrudes from the motor housing 60 into the gear housing 62. An end part of the shaft 21 protruding to the gear housing 62 is coupled to the transmission mechanism 3. Specifically, the shaft 21 is coupled to a first gear 41 of the transmission mechanism 3.

The stator 30 encloses the rotor 20 from radially outside. The stator 30 includes a stator core 32, a coil 31, and an insulator (not illustrated) interposed between the stator core 32 and the coil 31. The stator 30 is held by the motor housing 60. The coil 31 is connected to the inverter device 110 directly or via a bus bar (not illustrated).

The transmission mechanism 3 is accommodated in the gear housing 62. The transmission mechanism 3 is connected to the shaft 21 on one side in the axial direction of the motor axis J2. The transmission mechanism 3 includes a reduction gear 4 and a differential gear 5. Torque output from the motor 2 is transmitted to the differential gear 5 through the reduction gear 4.

The reduction gear 4 is connected to the shaft 21 of the motor 2. The reduction gear 4 has the first gear 41, a second gear 42, a third gear 43, and an intermediate shaft 45. The first gear 41 is coupled to the shaft 21 of the motor 2. The intermediate shaft 45 extends along an intermediate axis J4 parallel to the motor axis J2. The second gear 42 and the third gear 43 are fixed to both ends of the intermediate shaft 45. The second gear 42 and the third gear 43 are connected to each other via the intermediate shaft 45. The second gear 42 meshes with the first gear 41. The third gear 43 meshes with a ring gear 51 of the differential gear 5.

Torque output from the motor 2 is transmitted to the ring gear 51 of the differential gear 5 through the shaft 21 of the motor 2, the first gear 41, the second gear 42, the intermediate shaft 45, and the third gear 43. A gear ratio of each gear, the number of gears, and the like can be modified in various manners in accordance with a required reduction ratio. The reduction gear 4 is a speed reducer of a parallel-axis gearing type, in which axis centers of gears are arranged in parallel with one another.

The differential gear 5 transmits torque output from the motor 2 to an axle of a vehicle. The differential gear 5 transmits the torque to axles 55 of both the left and right wheels while absorbing the speed difference between the left and right wheels when the vehicle turns. The differential gear 5 includes a gear housing, a pinion gear, a pinion shaft, and a side gear (all not illustrated) in addition to the ring gear 51 meshing with the third gear of the reduction gear 4.

A lower region in the gear housing 62 is provided with an oil reservoir P in which the oil O accumulates. In the present embodiment, a bottom part of the motor housing 60 is located at a higher level than a bottom part of the gear housing 62. With this configuration, the oil O after the motor 2 is cooled can be easily collected from a lower region of the motor housing 60 to the oil reservoir P of the gear housing 62.

A part of the differential gear 5 soaks in the oil reservoir P. The oil O accumulated in the oil reservoir P is scraped up by operation of the differential gear 5. A part of the scraped oil O is supplied into the shaft 21. Another part of the oil O is diffused into the gear housing 62 and supplied to each gear of the reduction gear 4 and the differential gear 5. The oil O used for lubrication of the reduction gear 4 and the differential gear 5 is dropped and collected in the oil reservoir P located on the lower side of the gear housing 62.

The inverter device 110 includes an inverter 110a electrically connected to the motor 2 and an inverter case 120 accommodating the inverter 110a. The inverter 110a controls current to be supplied to the motor 2. The inverter case 120 is fixed to the motor housing 60. A cooling water pipe 95 extending from a radiator of the vehicle is connected to the inverter device 110. The cooling water pipe 95 extends to the oil cooler 9 via the inverter device 110.

The oil cooler 9 is located on a side surface of the motor housing 60. The cooling water pipe 95 extending from the inverter device 110 is connected to the oil cooler 9. The oil 0 discharged from an electric oil pump 10 is supplied to the oil cooler 9. The oil O passing through the inside of the oil cooler 9 is cooled through heat exchange with cooling water passing through the cooling water pipe 95.

The oil O cooled by the oil cooler 9 is supplied to the motor 2.

The electric oil pump 10 is an oil pump driven by a pump motor 10a. The electric oil pump 10 sucks up the oil O from the oil reservoir P and supplies the oil O to the oil cooler 9. The pump motor 10a rotates a pump mechanism of the electric oil pump 10. In the motor unit 1, a rotation axis J6 of the pump motor 10a is parallel to the motor axis J2. The electric oil pump 10 having the pump motor 10a tends to become long in a direction in which the rotation axis J6 extends. By making the rotation axis J6 of the pump motor 10a parallel to the motor axis J2, the electric oil pump 10 becomes less likely to protrude in the radial direction of the motor unit 1. This makes it possible to reduce the radial dimension of the motor unit 1.

As illustrated in FIG. 1, the oil O circulates in an oil passage 90 provided in the housing 6. The oil passage 90 is a path of the oil O for supplying the oil O from the oil reservoir P to the motor 2.

The oil O circulating in the oil passage 90 is used as lubricating oil for the reduction gear 4 and the differential gear 5 and as cooling oil for the motor 2. The oil O accumulates in the oil reservoir P in a lower part of the gear housing 62. Oil equivalent to automatic transmission fluid (ATF) having a low viscosity is preferably used as the oil O so that the oil O can perform functions of lubricating oil and cooling oil.

As illustrated in FIG. 1, the oil passage 90 is a path of the oil O that is guided from the oil reservoir Pon the lower side of the motor 2 to the oil reservoir P on the lower side of the motor 2 again via the motor 2. The oil passage 90 includes a first oil passage 91 passing through the inside of the motor 2 and a second oil passage 92 passing through the outside of the motor 2. The oil O cools the motor 2 from the inside and the outside through the first oil passage 91 and the second oil passage 92.

The oil O is scraped up by the differential gear 5 from the oil reservoir P, and is guided into an interior of the rotor 20 through the first oil passage 91. The oil O is sprayed from the rotor 20 toward the coil 31 to cool the stator 30. The oil 0 having cooled the stator 30 moves to the oil reservoir P of the gear housing 62 via the lower region of the motor housing 60.

In the second oil passage 92, the oil O is pumped up from the oil reservoir P by the electric oil pump 10. The oil O is pumped up to an upper part of the motor 2 via the oil cooler 9 and is supplied to the motor 2 from the upper side of the motor 2. The oil O having cooled the motor 2 moves to the oil reservoir P of the gear housing 62 via the lower region of the motor housing 60.

As illustrated in FIGS. 1 to 3, the inverter device 110 includes the inverter 110a and the inverter case 120 accommodating the inverter 110a inside the inverter case 120. The inverter case 120 includes a box-shaped case body 121 that opens upward, and a cover 122 that closes an opening of the case body 121 from above.

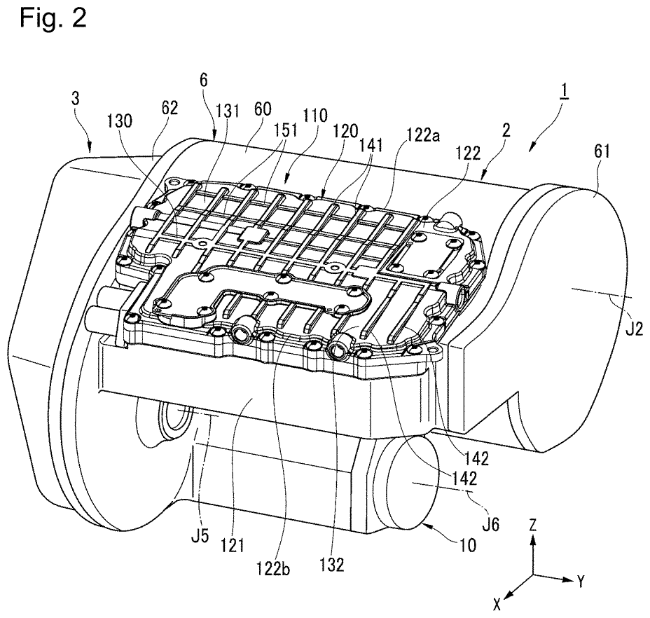

As illustrated in FIG. 2, the case body 121 is continuous to the outer peripheral surface of the motor housing 60. The case body 121 is located on the vehicle front side (+X side) of the motor housing 60. In the motor unit 1, the case body 121 and the motor housing 60 are a part of a single die casting member.

The cover 122 is a plate-like member that covers the inverter 110a from above. The cover 122 constitutes a top wall of the inverter case 120. In the present embodiment, the inverter case 120 has a configuration including the box-shaped case body 121 that opens upward and the plate-shaped cover 122, but other configurations can be adopted. For example, a configuration in which the case body 121 is opened in the axial direction (Y-axis direction), a configuration in which the case body 121 is opened to the vehicle front side (+X side), or a configuration in which the case body 121 is opened to the lower side (-Z side) maybe adopted. In these cases, the wall located at the upper end of the case body 121 is a top wall covering the inverter 110a from above.

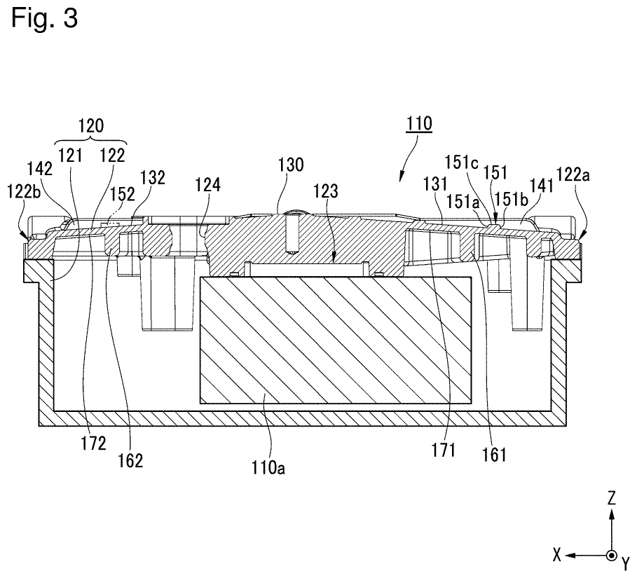

In the present embodiment, the inverter 110a is fixed to the lower surface of the cover 122 as illustrated in FIG. 3. According to this configuration, since the cover 122 and the inverter 110a can be unitized, the manufacturing process can be made efficient. The inverter device 110 may have a configuration in which the inverter 110a is fixed to the case body 121.

As illustrated in FIGS. 2 to 4, the cover 122 has a first inclined surface 131 descending from a top part 130 on the upper surface of the cover 122 toward a first end part 122a of the cover 122, and a second inclined surface 132 descending from the top part 130 toward a second end part 122b different from the first end part 122a.

The first end part 122a of the cover 122 is an end part on the vehicle rear side (−X side) in the motor unit 1. The second end part 122b is an end part on the vehicle front side (+X side) of the motor unit 1. The top part 130 is located midway between the first end part 122a and the second end part 122b in the vehicle front-rear direction (X-axis direction).

The top part 130 is a belt-shaped region extending along the vehicle left-right direction (Y-axis direction) when the motor unit 1 is viewed from above. From both end parts in the width direction of the top part 130, the first inclined surface 131 and the second inclined surface 132 expand toward the first end part 122a and the second end part 122b, respectively. In the present embodiment, the top part 130 is a topmost part located at the uppermost side on the upper surface of the cover 122. The top part 130 may exist at a plurality of places on the upper surface of the cover 122.

The top part 130 means an upper end part of a planar part facing upward in the upper surface of the cover 122, and does not include a site locally protruding from the upper surface of the cover 122. Examples of the site locally protruding from the upper surface of the cover 122 include a screw fixing boss, a screw head, or a first rod-shaped rib 141, a second rod-shaped rib 142, a first coupling rib 151, and a second coupling rib 152, which will be described later.

The first inclined surface 131 and the second inclined surface 132 may be inclined toward end parts of the cover 122 different from each other. The inclination direction of the first inclined surface 131 and the inclination direction of the second inclined surface 132 maybe directions that are parallel to each other or may be directions that intersect each other. For example, the inclination direction of the first inclined surface 131 and the inclination direction of the second inclined surface 132 may be configured to be orthogonal to each other.

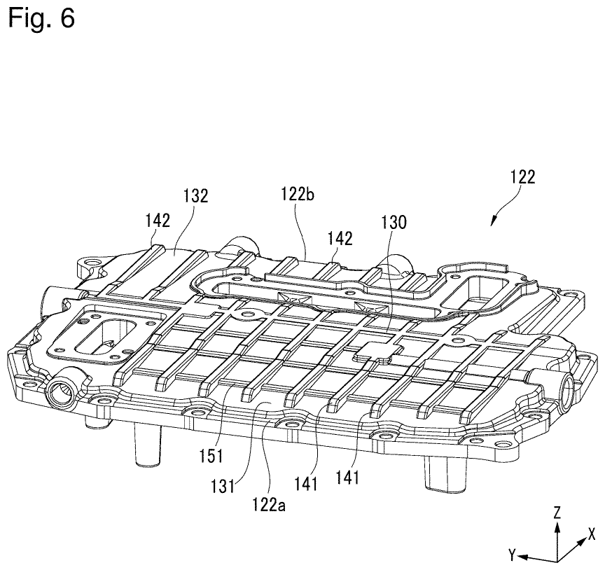

The cover 122 has a plurality of the first rod-shaped ribs 141 extending from the top part 130 toward the first end part 122a. As illustrated in FIGS. 3 and 6, the first rod-shaped rib 141 has a site where a protrusion height from the first inclined surface 131 increases toward the first end part 122a.

The cover 122 has a plurality of the second rod-shaped ribs 142 extending from the top part 130 toward the second end part 122b. The second rod-shaped rib 142 has a site where a protrusion height from the second inclined surface 132 increases toward the second end part 122b.

According to the above configuration, since both the first inclined surface 131 and the second inclined surface 132 of the cover 122 go down from the top part 130 toward the end part of the cover 122, even when water falls on the upper surface of the inverter device 110, the water on the upper surface of the cover 122 flows down along the first inclined surface 131 or the second inclined surface 132 to the first end part 122a or the second end part 122b. This makes it difficult for water to accumulate on the inverter device 110.

Since the first rod-shaped rib 141 extends along the first inclined surface 131 and the second rod-shaped rib 142 extends along the second inclined surface 132, water flowing on the first inclined surface 131 and the second inclined surface 132 smoothly flows to the end part of the cover 122 without being obstructed by the first rod-shaped rib 141 and the second rod-shaped rib 142, and is discharged to the outside of the cover 122.

Since the first inclined surface 131 and the second inclined surface 132 have the first rod-shaped rib 141 and the second rod-shaped rib 142, membrane resonance is suppressed on both of the first inclined surface 131 and the second inclined surface 132. Therefore, generation of noise in the motor unit 1 can be suppressed.

The protrusion height of the first rod-shaped rib 141 from the first inclined surface 131 increases toward the first end part 122a, and the protrusion height of the second rod-shaped rib 142 from the second inclined surface 132 increases toward the second end part 122b. According to this configuration, since the protrusion heights of the first rod-shaped rib 141 and the second rod-shaped rib 142 in the vicinity of the top part 130 are suppressed, it is possible to suppress the thickness of the cover -122 from becoming excessively large. On the other hand, since the first rod-shaped rib 141 and the second rod-shaped rib 142 can secure the required protrusion height at the end part of the cover 122, it is easy to secure the rigidity with which the noise suppression effect can be obtained.

In the present embodiment, both the first rod-shaped rib 141 and the second rod-shaped rib 142 are configured to extend in the vehicle front-rear direction (X-axis direction), but any one or both of the first rod-shaped rib 141 and the second rod-shaped rib 142 may be configured to extend in a direction intersecting the vehicle front-rear direction (X-axis direction).

As in the present embodiment, when the direction from the top part 130 toward the first end part 122a is the vehicle front-rear direction, the direction in which the first rod-shaped rib 141 extends can be a direction intersecting the vehicle front-rear direction within a range of less than ±45°. The same applies to the second rod-shaped rib 142. By setting the intersection angle to the above range, it is possible to suppress the flow of water along the first inclined surface 131 and the second inclined surface 132 from being obstructed by the first rod-shaped rib 141 and the second rod-shaped rib 142.

In the present embodiment, the cover 122 is configured to have the first inclined surface 131 and the second inclined surface 132, but the cover 122 may be configured to only have any one of the first inclined surface 131 and the second inclined surface 132. For example, even in a case where the cover 122 has only the first inclined surface 131, the water having fallen on the upper surface of the inverter device 110 flows down on the first inclined surface 131 located between the plurality of first rod-shaped ribs 141 from the top part 130 toward the first end part 122a. This makes it possible to suppress water from accumulating on the upper surface of the inverter device 110.

The cover 122 may be configured to have three or more inclined surfaces. Also in this case, by making the three or more inclined surfaces inclined surfaces descending from the top part 130 toward the peripheral edge part of the cover 122, it is possible to achieve a configuration in which water is less likely to accumulate on the upper surface of the cover 122.

The cover 122 has a plurality of the first coupling ribs 151 that couple two of the first rod-shaped ribs 141 arranged next to each other . In the case of the present embodiment, two or three of the first coupling ribs 151 are bridged between the two of the first rod-shaped ribs 141 arranged next to each other.

According to this configuration, the plurality of first coupling ribs 151 can reinforce the plurality of first rod-shaped ribs 141. Membrane vibration of the first inclined surface 131 can be further suppressed by improving the strength of the rib supporting the first inclined surface 131. Noise caused by membrane resonance of the first inclined surface 131 can be reduced.

In the cover 122, as illustrated in FIG. 3, the individual first coupling ribs 151 have a protrusion height of a side surface 151a facing the top part 130 side from the first inclined surface 131 that is smaller than a protrusion height of a side surface 151b facing the first end part 122a side from the first inclined surface 131.

According to this configuration, when water flows from the top part 130 side with respect to the first coupling rib 151, since the side surface 151a on the top part 130 side is low, the water easily gets over the first coupling rib 151. Therefore, it is possible to provide the inverter device 110 in which water is less likely to accumulate on the upper surface of the cover 122.

An upper surface 151c of the first coupling rib 151 is preferably a flat surface expanding in the horizontal direction or a flat surface having an inclination of equal to or less than 10° with respect to the horizontal direction. According to this configuration, it becomes possible to easily secure the height of the first coupling rib 151 while causing water to easily flow on the first inclined surface 131. It becomes easy to secure the rigidity of the first coupling rib 151.

The upper surface 151c may be an inclined surface descending toward the first end part 122a. According to this configuration, the water having flown onto the upper surface 151c easily flows to the first end part 122a side.

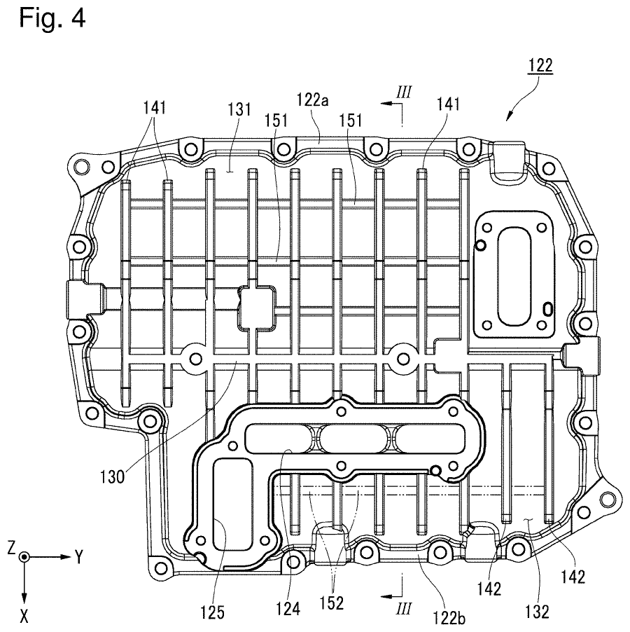

The cover 122 may have a coupling rib also on the second inclined surface 132 similar to that on the first inclined surface 131 side. That is, as illustrated in FIGS. 3 and 4, the cover 122 may be configured to have the plurality of second coupling ribs 152 that couple two of the second rod-shaped ribs 142 arranged next to each other, and the individual second coupling ribs 152 may have a configuration in which a protrusion height of a side surface facing the top part 130 side from the second inclined surface is smaller than a protrusion height of a side surface facing the second end part 122b side from the second inclined surface. According to this configuration, the strength of the ribs can be increased even on the second inclined surface 132. Membrane resonance is less likely to occur on the second inclined surface 132, and noise is reduced.

As illustrated in FIGS. 3 and 4, the cover 122 has a honeycomb-shaped lower surface rib 161 on the lower surface of the cover 122. The lower surface rib 161 has a configuration in which regular hexagonal annular ribs are arranged without a gap on the lower surface of the cover 122. The honeycomb-shaped lower surface rib 161 is excellent in flexural strength and compressive strength as compared with other polygonal ribs. Therefore, by providing the cover 122 with the honeycomb-shaped lower surface rib 161, it is possible to increase the rigidity of the cover 122, and it is possible to provide a thin, low-noise cover.

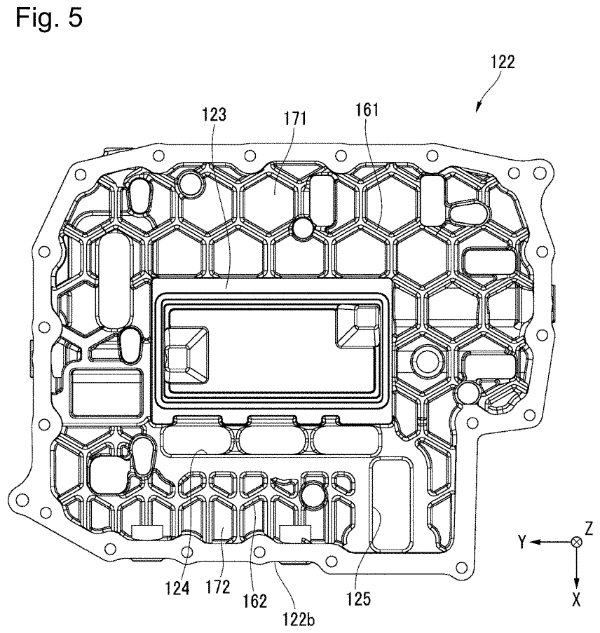

As illustrated in FIGS. 3 and 5, the cover 122 has a first back side inclined surface 171 following the first inclined surface 131 on the back side of the first inclined surface 131. As illustrated in FIG. 3, the lower surface rib 161 located on the first back side inclined surface 171 has a larger protrusion height downward from the first back side inclined surface 171 toward the top part 130.

On the upper surface of the cover 122, the first rod-shaped rib 141 has a small protrusion height in the vicinity of the top part 130. By making the protrusion height of the lower surface rib 161 relatively high in the vicinity of the top part 130, it becomes easily to secure the rigidity of the entire top part 130. Since the protrusion height of the first rod-shaped rib 141 can be reduced in the vicinity of the top part 130, the upper surface of the inverter device 110 can be easily flattened, so that a space with components located around the motor unit 1 can be easily secured in the vehicle.

As illustrated in FIGS. 3 to 5, the cover 122 has through holes 124 and 125 penetrating the cover 122 in the up-down direction. The through hole 124 and the through hole 125 are, for example, access ports into which a tool for electrically connecting the inverter 110a and the stator 30 of the motor 2 is inserted.

As illustrated in FIGS. 3 and 5, the cover 122 has a trapezoidal lower surface rib 162 located in the vicinity of the through holes 124 and 125 in the lower surface of the cover 122. The lower surface rib 162 of the present embodiment has a configuration in which a plurality of trapezoidal annular ribs are arranged without a gap on the lower surface of the cover 122. The lower surface rib 162 is located in a region surrounded by the through hole 124 and the through hole 125 and the outer peripheral edge of the cover 122.

In the present embodiment, the “trapezoidal rib” is not limited to a geometrically accurate trapezoidal annular rib. The “trapezoidal rib” of the present embodiment may be an annular rib including at least two linear ribs parallel to each other and at least one linear rib bridged between the two linear ribs.

As illustrated in FIG. 5, the lower surface rib 162 includes more linear ribs than that of the honeycomb-shaped lower surface rib 161. According to the lower surface rib 162, it is easy to obtain higher rigidity than the honeycomb-shaped lower surface rib 161. In the cover 122, the sites where the through holes 124 and 125 are provided is liable to decrease in rigidity, and therefore, by arranging the trapezoidal lower surface rib 162 in the vicinity of the through holes 124 and 125, it becomes easy to secure the rigidity of the cover 122.

The shape of the lower surface rib 162 can also be described as a shape in which two vertices of the honeycomb-shaped rib are connected by a linear rib passing through the inside of the hexagon. By having the linear rib connecting the vertices of the honeycomb, the area of the region surrounded by the rib is smaller and the installation density of the ribs becomes larger than those of a simple honeycomb-shaped rib. This increase the rigidity of the lower surface rib 162, and increases the noise reduction effect by the lower surface rib 162.

As illustrated in FIG. 3, the cover 122 has a second back side inclined surface 172 following the second inclined surface 132 on the back side of the second inclined surface 132. The lower surface rib 162 located on the second back side inclined surface 172 has a larger protrusion height from the second back side inclined surface 172 toward the top part 130.

Also on the second inclined surface 132, since the protrusion height of the second rod-shaped rib 142 is relatively low in the vicinity of the top part 130, the rigidity of the entire top part 130 can be easily secured by making the protrusion height of the lower surface rib 162 relatively high in the vicinity of the top part 130. Since the protrusion height of the second rod-shaped rib 142 can be reduced in the vicinity of the top part 130, the upper surface of the inverter device 110 can be easily flattened, so that a space with components located around the motor unit 1 can be easily secured in the vehicle.

The cover 122 has a refrigerant flow path 123 in a central part when the cover 122 is viewed from below. The cooling water pipe 95 illustrated in FIG. 1 is connected to the refrigerant flow path 123. The inverter 110a attached to the lower surface of the cover 122 is cooled by the cooling water flowing through the refrigerant flow path 123. The cover 122 may be configured not to include the refrigerant flow path 123.

In the above embodiment, the motor unit 1 including the motor 2, the transmission mechanism 3, and the inverter device 110 has been described, but the motor unit 1 may be configured to include only the motor 2 and the inverter device 110.

That is, the embodiment of the present invention can also be configured as a motor including the rotor 20, the stator 30, the motor housing 60 that accommodates the rotor 20 and the stator 30, and the inverter device 110 arranged in contact with the motor housing 60.

In the motor, the motor housing 60 and the inverter case 120 may be a part of a single die casting member similarly to the previous embodiment. Alternatively, the motor housing 60 and the inverter case 120 formed of separate members from each other may be included. Even if the inverter case 120 and the motor housing 60 are separate components, when they are arranged in contact with each other, vibration of the motor is transmitted to the inverter case 120. Since the inverter device 110 includes the cover 112 of the embodiment, vibration of the inverter case 120 can be suppressed, and a puddle on the upper surface is less likely to occur.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An inverter device comprising:
an inverter; and
an inverter case that accommodates the inverter inside the inverter case,
wherein the inverter case has a top wall covering the inverter from above,
the top wall includes
a first inclined surface descending from a top part on an upper surface of the top wall toward a first end part of the top wall, and
a plurality of first rod-shaped ribs extending from the top part toward the first end part, and
the first rod-shaped rib has a site in which a protrusion height from the inclined surface increases toward the first end part.

2. The inverter device according to claim 1, comprising
a plurality of first coupling ribs coupling two of the first rod-shaped ribs arranged next to each other,
wherein each of the first coupling ribs has a protrusion height of a side surface facing a top part side from the first inclined surface that is smaller than a protrusion height of a side surface facing a first end part side from the first inclined surface.

3. The inverter device according to claim 1, wherein
the top wall includes
a second inclined surface descending from the top part toward a second end part different from the first end part, and
a plurality of second rod-shaped ribs extending from the top part toward the second end part, and
the second rod-shaped rib has a site in which a protrusion height from the inclined surface increases toward the second end part.

4. The inverter device according to claim 3, comprising a plurality of second coupling ribs coupling two of the second rod-shaped ribs arranged next to each other,
wherein each of the second coupling ribs has a protrusion height of a side surface facing a top part side from the second inclined surface that is smaller than a protrusion height of a side surface facing a second end part side from the second inclined surface.

5. The inverter device according to claim 2, wherein an upper surface of the coupling rib is a flat surface expanding in a horizontal direction or a flat surface having an inclination of equal to or less than 10° with respect to the horizontal direction.

6. The inverter device according to claim 1, wherein the top wall includes a honeycomb-shaped lower surface rib on a lower surface of the top wall.

7. The inverter device according to claim 1, wherein
the top wall includes
a through hole penetrating the top wall in an up-down direction, and
a lower surface rib located in a vicinity of the through hole on the lower surface of the top wall.

8. The inverter device according to claim 7, wherein the lower surface rib located in the vicinity of the through hole has a shape in which two vertices of a honeycomb-shaped rib are connected by a linear rib passing through an inside of a hexagon.

9. The inverter device according to claim 6, wherein
the top wall has a first back side inclined surface following the first inclined surface on a back side of the first inclined surface, and
the lower surface rib located on the first back side inclined surface has a site where a protrusion height from the first back side inclined surface increases toward the top part.

10. The inverter device according to claim 6, wherein
the top wall has a second inclined surface descending from the top part toward a second end part different from the first end part, and
the top wall has a second back side inclined surface following the second inclined surface on a back side of the second inclined surface, and the lower surface rib located on the second back side inclined surface has a site where a protrusion height from the second back side inclined surface increases toward the top part.

11. A motor comprising:
a rotor and a stator;
a motor housing that accommodates the rotor and the stator; and
the inverter device according to claim 1 arranged in contact with the motor housing.

12. The motor according to claim 11, wherein the inverter case and the motor housing have a site formed of a common single member.

13. A motor unit comprising:
the motor according to claim 11; and
a transmission mechanism that couples the motor and an axle.
